(19) United States
(12) Patent Application Publication
(10) Pub. No.: US 2012/0279905 A1
(43) Pub. Date: Nov. 8, 2012

(54) Safe storage of hazardous materials

(76) Inventor: Patrick Whitty, Stoney Creek (CA)

(21) Appl. No.: 13/068,151

(22) Filed: May 4, 2011

(51) Int. Cl. B07C 5/342; B07C 5/02

(52) U.S. Cl. 209/3.3; 209/522

(57) ABSTRACT

A method of safely storing containers containing chemical substances in accordance with a preconceived plan which comprises; examining each container to assure the integrity of each container containing such chemical substances and that said container is suitable for the storage of its contents for a predetermined period of time. If the container is deemed fit to store the contents, then, the exterior of the container is examined for exterior marks which will help to determine what the contents really are. Next a classification scheme for the said chemical substances is developed. This entails the establishment of a colour to be applied to the exterior surface of said container after a determination of the container's contents has been made. A corresponding number to be applied to the external surface of each container. The number of classes must next be determined for the plan (arbitrary). This is established in determining how and where the substances so classified may be safely stored, sorting the containers into like groups and storing the groups of containers marked with the same colours and numbers in accordance with the plan.

### BACKGROUND OF THE INVENTION

The storage of chemicals etc. in a modern laboratory is generally considered to be an afterthought which must be endured after the main event has taken place. Little thought has generally been given as to how the storage of chemical substances may be improved with safety of the system always being the criterion.

It has been the practice of those persons that are in control of educational facilities such as science laboratories etc. to employ unsafe (at best) storage techniques of unused hazardous substances (chemicals etc.) when such hazardous substances have been partially used and are to be put away for indeterminate periods of time. When unused materials must be stored until such time as such materials are again required, such materials are stored in storage containers in a storage cupboard provided for that purpose with little thought being given to the safety of such storage containers and their contents in the space provided. The selection of a such space for such materials has usually taken the form of a contractor provided storage cupboard and it is often questioned whether such materials may be safely stored at all in the provided space.

The materials stored may be chemical substances that require separation from other specified chemical substances in order that two stored substances do not have any opportunity to mix or contaminate each other (sometimes with drastic results). It will be remembered that such materials may exist in liquid, powder and gaseous forms. Storage techniques for such chemical substances will take many different forms in order to satisfactorily safely contain them.

Thus we generally find that partially filled containers of vicious acids are stored in manufacturer's shipping containers in such a cupboard alongside substances that will react with the vicious acids if given an opportunity.

Persons in the academic world tend to treat the storage of hazardous substances such as chemicals as being of little importance. Statements such as “we've always stored them in that cupboard and up to now we haven't had any problem” regularly abound and are put forth as evidence that such storage systems are satisfactory. No thought is generally given to the placement of such materials in the storage area. It is to be remembered that persons in charge of the storage of such chemical substances are not particularly interested in the safety of such procedures, as long as the chemical materials are stored. For this reason the following classification and storage system is simple and easy to follow.

### DESCRIPTION OF THE PREFERRED EMBODIMENT OF THE INVENTION

The solution provided here is to classify the substances to be stored and assign an identifying colour and number to each substance so classified. In this manner one has only to look in the storage facility and the state of the stored goods will be known. First, a number of classes must be chosen so that a colour and number may be assigned to each class of substances of the group. This method of classification allows one the opportunity to separate incompatible substances during storage. For a start, eight (arbitrary) classifications of chemical substances has been chosen.

A suggested colouring and numbering guide might be as follows:

| Number | Colour | | Examples of Materials stored in Group |
|---|---|---|---|
| 1. | White Dot | Inorganic Acids—Acidic | Sulphuric, Hydrochloric, Phosphoric |
| | | Inorganic Solutions/ | and Boric Acid, Copper, Tin, Ferric, |
| | | Salts | and Zinc Chlorides, Copper and |
| | | | Cupric Sulphates, Sodium Sulphate. |
| 2. | Orange Dot | Strong Organic | Glacial Acetic, Oxalic, and Butyric |
| | | Acids—(Smelly acids.) | Acids. |
| 3. | Blue Dot | Inorganic Alkali | Ammonium, Barium, Sodium, |
| | | Solutions. | Potassium & Zinc Hydroxide; |
| | | | Sodium & Potassium Phosphate; |
| | | | Magnesium, Calcium and & Zinc |
| | | | Oxides; |
| | | Inorganic Alkaline | Potassium, Sodium & Barium |
| | | Salts and Inorganic | Chlorides; |
| | | Salts that Decompose | Sodium & Zinc Sulphides; |
| | | on Contact With Acids. | Sodium Thiosulphates. |
| 4. | Brown Dot | Inorganic Cyanides | Sodium & Potassium Cyanide; |
| | | Thiocyanate | Potassium Thiocyanate; |
| | | Ferri/Ferrocyanides | Ferric, Ferrous, Ferrocyanide |
| | | | Ferricyanide. |
| 5. | Neon Red | Non-flammable Organic | Formalin; Starch; methyl |
| | Dot | Liquids, | Orange; Malachite Green; |
| | | Organic Solids | Acetylsalicylic Acid; Ethylene |
| | | | Glycol; Propylene Glycol; |
| | | | Glycerin; Glycerol; Water |
| | | | Based Indicating Solutions such |
| | | | as Sodium Benzoate; Benzoic |
| | | | Acid; Citric Acid; Sodium |
| | | | Acetate. |
| 6. | Red Dot | Flammable Organic | Isopropyl Alcohol; |
| | | Liquids— | Methanol; Ethanol; |
| | | | Propanol; Butanol; |
| | | | Acetone; Cyclohexane; |
| | | | Phenolphthalien; and |
| | | | Denatured Alcohol. |
| 7. | Yellow Dot | Inorganic Oxidizing | Nitric acid (greater than |
| | | Acids, and Oxidizing | 70% by volume) |
| | | Liquids or Solids; | Perchloric Acid; Silver, |
| | | | Sodium & Lead Nitrate; |
| | | | Sodium & Hydrogen Peroxide; |
| | | | Potassium & Sodium |
| | | | persulphate; Potassium |
| | | | Bromate; Sodium Periodate. |
| 8. | Black Dot | Air, Water, and shock | Calcium; Sodium; |
| | | Sensitive | Lithium & Magnesium |
| | | | Metals; Zinc Dust; |
| | | | Sulphur(finely divided); |
| | | | Calcium Carbide; |
| | | | Metals in Fine Powder |
| | | | Form; Carbon &Charcoal. |

It is seen that, in this instance, the grouping of chemical substances into eight groups is sufficient for this application.

The “DOT” confinement is another arbitrarily chosen configuration which is speedy and helps quickly identify the chemical substance inside the container. In this way the colour dot is a convenient way of representing the chemicals inside the container. Other methods are possible but this method was chosen for convenience and simplicity.

Under no circumstances may materials having different colour dot

designations be stored in the same space as other materials bearing different colour dot designations.

These are the general rules of storage of “Marked” Chemical Materials. The containers bearing such Chemical Materials must first be investigated to insure the integrity of the containers containing the Marked Chemical Materials. If there is any chance that a container has been exchanged (for one of a more convenient size etc.) the container and its contents are immediately discarded.

Any container that is unmarked or which contains a material, of which the contents are not readily identifiable, will also be discarded to a site which can safely dispose of the unidentified material. There are other situations which will be encountered from time to time which shall be cause for alarm, but the materials would be tested to determine the hazardous characteristics of the unidentified materials. The tests will allow the previously unidentified materials to be identified or at least be classified and disposed of accordingly. It has been found that it is better to err on the side of safe disposal (for reasons of safety) rather than trying to identify the unknown chemical substance and store it for use at a later date.

Many modifications and other embodiments of the invention will come to mind of one skilled in the art, having the benefit of the teachings presented in the foregoing description and the associated drawings. Therefore, it is to be understood that the invention is not to be limited to the specific embodiments included in this description but will be defined within the scope of the following claims attached hereto.

1. A method of safely storing a group of chemical substances contained in containers in a suitable cupboard comprising:
examining said containers containing said chemical substances to assure that the said containers containing such chemical substances may be safely stored in said containers,
determining a number of classes of chemical substances into which said group may be divided, and
examining each container to assure that the contents of said container comply with the marking that has previously applied to the exterior of surface of said container, determining the marking's accuracy, and applying a colour and a number to the exterior surface of said container, in accordance with the previous classification, and
classifying each and every container of said group in appropriate classes of chemical substances and applying a colour and corresponding number to the external surfaces of said containers of such chemical substances, and
separating said containers into groups in accordance with colour and number previously applied for safe storage of said chemical substances, and storing said containers of chemical substances in groups according to the colour coding and numerical designation previously applied to said to each container in a cupboard.

2. The method in accordance with claim 1 which entails the storage of containers bearing similar colours and numerical markings in cubicles of the same storage cupboard.

3. The method as claimed in claim 1 wherein no two containers bearing different colours are placed in the same cubicle of the storage cupboard.

4. The method as claimed in claim 1 in which the determination of the classes is eight or less.

5. The method as claimed in claim 1 in which the determination of the classes is eight or more.

6. A method of storing containers of chemical substances useful in performing experiments in the science laboratories in high schools comprising:
examining each container to determine if it meets predetermined integrity standards of such storage containers,
examining each container to determine if has any markings on the exterior surface thereof, to provide some indication of what the contents of the container might be,
determining what each container contains, and subsequently marking on each container a colour indicator and a corresponding reference numeral on the exterior surface thereof in accordance with what said container contains,
storing each group of similarly marked containers in the same cubicle of a storage cupboard.

7. The method as claimed in claim 6 wherein no two containers bearing different colours are placed in the same cubicle of the storage cupboard.

8. The method as claimed in claim 6 in which the determination of the classes is eight or less.

9. The method as claimed in claim 6 in which the determination of the classes is nine or more.

10. A method of storing containers of chemical substances useful in performing experiments in the science laboratories in high schools comprising:
examining each container to determine if it meets predetermined integrity standards of such storage containers, separating the containers into groups as hereinafter specified:

| | | | |
|---|---|---|---|
| 1. | White Dot | Inorganic Acids—Acidic | Sulphuric, Hydrochloric, Phosphoric |
| | | Inorganic Solutions/ | and Boric Acid, Copper, Tin, Ferric, |
| | | Salts | and Zinc Chlorides, Copper and |
| | | | Cupric Sulphates, Sodium Sulphate. |
| 2. | Orange Dot | Strong Organic | Glacial Acetic, Oxalic, and Butyric |
| | | Acids—(Smelly acids.) | Acids. |
| 3. | Blue Dot | Inorganic Alkali | Ammonium, Barium, Sodium, |
| | | Solutions. | Potassium & Zinc Hydroxide; |
| | | | Sodium & Potassium Phosphate; |
| | | | Magnesium, Calcium and & Zinc |
| | | | Oxides; |
| | | Inorganic alkaline | Potassium, Sodium & Barium |
| | | Salts and inorganic | Chlorides; |
| | | Salts that decompose | Sodium & Zinc Sulphides; |
| | | on contact with acids. | Sodium Thiosulphates. |
| 4. | Brown Dot | Inorganic Cyanides | Sodium & Potassium Cyanide; |
| | | Thiocyanate | Potassium Thiocyanate; |
| | | Ferri/Ferrocyanides | Ferric, Ferrous, Ferrocyanide |
| | | | Ferricyanide. |
| 5. | Neon Red | Non-flammable Organic | Formalin; Starch; methyl |
| | Dot | Liquids, | Orange; Malachite Green; |
| | | Organic Solids | Acetylsalicylic Acid; Ethylene |
| | | | Glycol; Propylene Glycol; |
| | | | Glycerin; Glycerol; Water |
| | | | Based Indicating Solutions such |
| | | | as Sodium Benzoate; Benzoic |
| | | | Acid; Citric Acid; Sodium |
| | | | Acetate. |
| 6. | Red Dot | Flammable Organic | Isopropyl Alcohol; |
| | | Liquids— | Methanol; Ethanol; |
| | | | Propanol; Butanol; |
| | | | Acetone; Cyclohexane; |
| | | | Phenolphthalien; and |
| | | | Denatured Alcohol. |
| 7. | Yellow Dot | Inorganic Oxidizing | Nitric acid (greater than |
| | | Acids, and Oxidizing | 70% by volume) |
| | | Liquids or Solids; | Perchloric Acid; Silver, |
| | | | Sodium & Lead Nitrate; |
| | | | Sodium & Hydrogen Peroxide; |
| | | | Potassium & Sodium |
| | | | persulphate; Potassium |
| | | | Bromate; Sodium Periodate |
| 8. | Black Dot | Air, Water, and shock | Calcium; Sodium; |
| | | Sensitive | Lithium & Magnesium |
| | | | Metals; Zinc Dust; |
| | | | Sulphur(finely divided); |
| | | | Calcium Carbide; |
| | | | Metals in Fine Powder |
| | | | Form; Carbon &Charcoal. |

examining each container to determine if has any markings on the exterior surface thereof, to provide some indication of what the contents of the container might be,
determining what the contents of said container really are, if there are no markings on the exterior surface of said container, disposing of said container and if no determination of the contents can be made or marking the exterior surface of said container with markings corresponding to the contents thereof,
storing each container of similar markings on the exterior surface thereof in the same cubicles in said cupboard.
